(19) United States
(12) Patent Application Publication
(10) Pub. No.: US 2014/0377532 A1
(43) Pub. Date: Dec. 25, 2014

(54) ADHESIVE TAPE

(71) Applicant: HON HAI PRECISION INDUSTRY CO., LTD., New Taipei (TW)

(72) Inventors: PEI-RONG SHIEH, New Taipei (TW); CHANG-CHIN WU, New Taipei (TW)

(73) Assignee: HON HAI PRECISION INDUSTRY CO., LTD., New Taipei (TW)

(21) Appl. No.: 14/057,202

(22) Filed: Oct. 18, 2013

(30) Foreign Application Priority Data
Jun. 19, 2013 (TW) 102121638

(51) Int. Cl. C09J 7/02; C09J 11/04; C09J 11/08

(52) U.S. Cl. CPC C09J 7/02; C09J 11/08; C09J 11/04
USPC 428/313.5; 428/313.3; 428/313.9

(57) ABSTRACT

An adhesive tape is disclosed. The adhesive tape includes a protective layer, an adhesive layer formed on the protective layer, and a plurality of bearing particles dispersed in the adhesive layer. The bearing particles are hollow and elastic. An impact resistance of the adhesive tape is improved, and an adhering performance is improved.

### BACKGROUND

1. Technical Field

The present disclosure relates to adhesive tapes, and particularly to a double-sided adhesive tape.

2. Description of the Related Art

A double-sided adhesive tape includes a base layer and two adhesive layers formed on opposite surfaces of the base layer. The base layer is made of foam having air bubbles. The air bubbles are formed by expanding resin particles in a chemical method or by introducing air into the foam in a physical method. In those methods, the sizes of the air bubbles are difficult to control. Some air bubbles may be broken when the adhesive tape comes under stress. Thus, in use, the double-sided adhesive tape suffers an uneven stress, so that the double-sided adhesive tape cannot bear a predetermined force.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 shows a partial, cross-sectional view of a first embodiment of an adhesive tape.

FIG. 2 is similar as FIG. 1, but showing the adhesive tape in a use state.

FIG. 3 shows a partial, cross-sectional view of a second embodiment of an adhesive tape.

FIG. 4 is similar as FIG. 3, but showing the adhesive tape in a use state.

### DETAILED DESCRIPTION

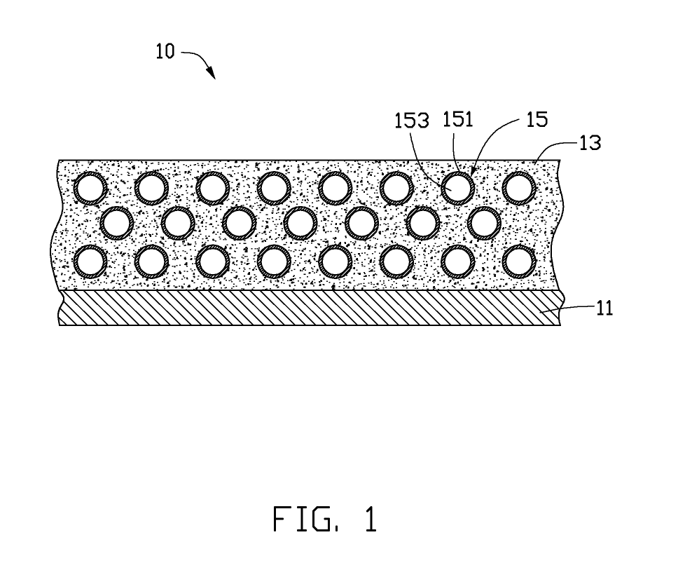

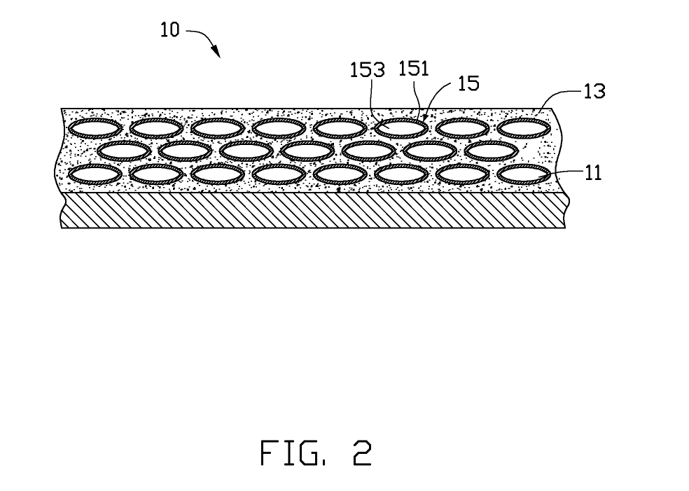

FIGS. 1 and 2 show a first embodiment of an adhesive tape 10. The adhesive tape 10 includes a protective layer 11, an adhesive layer 13 formed on the protective layer 11, and a plurality of bearing particles 15 dispersed in the adhesive layer 13. The protective layer 11 is made of release paper. The adhesive layer 13 is made of adhesive, for adhering to articles (not shown). The bearing particle 15 is hollow and spherical, and includes an elastic shell 151. The elastic shell 151 is closed, thereby forming a cushion space 153. The elastic shell 151 is made of materials selected from one or more of the following materials: organic polymer, metal, or ceramic. For example, the organic polymer is selected from one or more of the group consisting of vinylidene chloride acrylonitrile copolymer, poly (vinyl alcohol), poly (vinyl butyral), polymethyl methacrylate (PMMA), polyacrylonitrile, poly (vinylidene chloride), and polysulfones. The metal can be stain steel, titanium, copper, or their alloy. The ceramic can be silicon dioxide-organic polymer hybrid material or hollow glass ceramic.

In the first embodiment, the bearing particle 15 is made of vinylidene chloride acrylonitrile copolymer. A size of the bearing particle 15 is about a quarter of a thickness of the adhesive layer 13. A density of the bearing particles 15 and the adhesive layer 13 is about 0.6 kilograms per cubic meter. The size of the bearing particle 15 is defined as R, and the thickness of the adhesive layer 13 is defined as D. In other embodiments, R is not limited as in the first embodiment, as long as 0.1 D<R<0.9 D. The density of the bearing particles 15 and the adhesive layer 13 can be in a range from about 0.3 kilograms per cubic meter to about 0.9 kilograms per cubic meter. In the first embodiment, the bearing particles 15 are uniformly dispersed in the adhesive layer 13.

In the first embodiment, the adhesive tape 10 employs the bearing particles 15 as a base layer. When the adhesive tape 10 comes under stress, the bearing particles 15 are deformed elastically (referring to FIG. 2), and not easily broken, such that the stress is dispersed effectively, and uniformly exerted on the adhesive tape 10. Thus, an impact resistance of the adhesive tape 10 is improved, and an adhering performance is improved. A glass transition temperature of the bearing particle 15 is high, so that a temperature resistance of the adhesive tape 10 is higher, and a shearing strength of the adhesive tape 10 is improved. In addition, the adhesive tape 10 has a simpler structure, has a simpler manufacturing process. First, the bearing particles 15 are dispersed in the adhesive. The adhesive is coated on the protective layer 11. Furthermore, a predetermined function of the adhesive tape 10 can be met by designing the bearing particles 15. For example, if a better cushion performance of the adhesive tape 10 is needed, a density of the bearing particles 15 can be lower or a distribution density of the bearing particles 15 can be greater. Or, if a better waterproof performance of the adhesive tape 10 is needed, the elastic shell 151 can be in a closed structure.

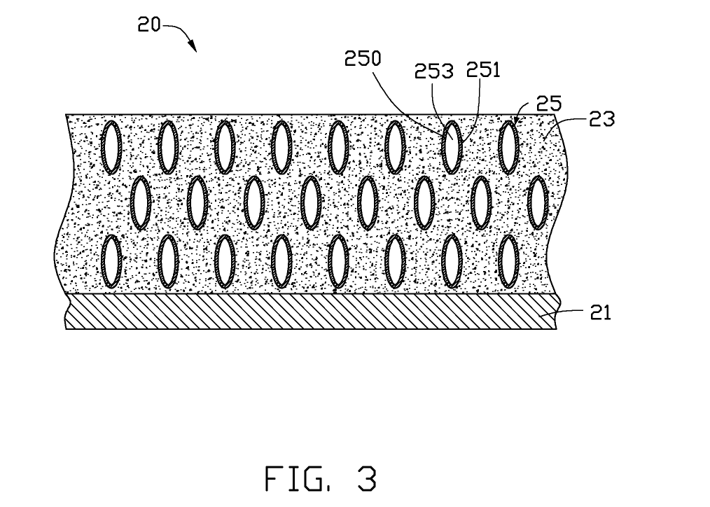

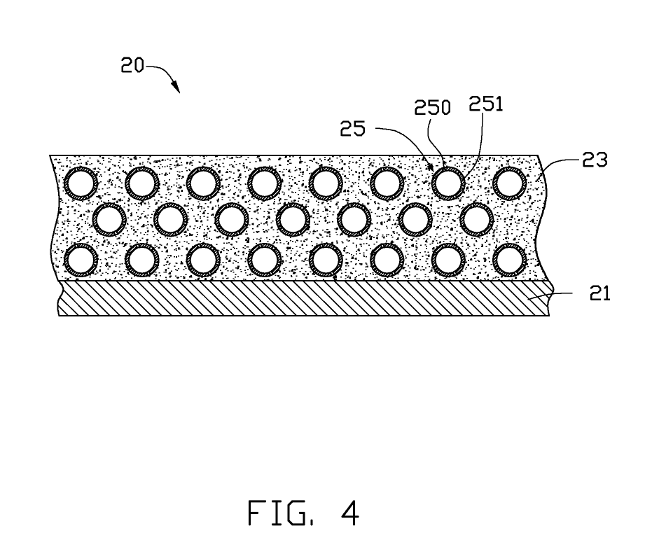

FIGS. 3 and 4 show a second embodiment of an adhesive tape 20. The adhesive tape 20 is similar to the first embodiment of the adhesive tape 10, and includes a protective layer 21, an adhesive layer 23 formed on the protective layer 21, and a plurality of bearing particles 25 dispersed in the adhesive layer 23. However, each bearing particle 25 is hollow and elliptical, and defines a plurality of through holes 250 communicating to a cushion space 253, to further improve an elasticity of the bearing particle 25. In use, if the adhesive tape 20 comes under stress, the bearing particles 25 are deformed (shown in FIG. 4).

The bearing particles 15, 25 are note limited to above-described shapes, and can be in other shapes, regular or irregular, such as cubic or polygon.

It is to be understood, however, that even though numerous characteristics and advantages of the disclosure have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. An adhesive tape, comprising:
a protective layer;
an adhesive layer formed on the protective layer; and
a plurality of bearing particles dispersed in the adhesive layer, each of the bearing particles being hollow and elastic.

2. The adhesive tape of claim 1, wherein the plurality of bearing particles is made of materials selected from a group consisting of the following materials: organic polymer, metal, and ceramic.

3. The adhesive tape of claim 2, wherein the plurality of bearing particles is made of materials selected from a group consisting of vinylidene chloride acrylonitrile copolymer, poly (vinyl alcohol), poly (vinyl butyral), polymethyl methacrylate, polyacrylonitrile, poly (vinylidene chloride), and polysulfones.

4. The adhesive tape of claim 2, wherein the plurality of bearing particles is made of materials selected from a group consisting of stain steel, titanium, copper, and their alloy.

5. The adhesive tape of claim 2, wherein each of the bearing particles comprises a closed shell, and the shell forms a cushion space.

6. The adhesive tape of claim 2, wherein each of the bearing particles comprises a shell having a cushion space, and the shell defining a plurality of through holes communicating with the cushion space.

7. The adhesive tape of claim 1, wherein each of the bearing particles is spherical or elliptical.

8. The adhesive tape of claim 1, wherein the plurality of bearing particles are uniformly dispersed in the adhesive layer.

9. The adhesive tape of claim 1, wherein a size of the each of the plurality of bearing particles is in a range of from about 1/10 of a thickness of the adhesive layer to about 9/10 of a thickness of the adhesive layer.

10. The adhesive tape of claim 1, wherein a density of the plurality of bearing particles and the adhesive layer is in a range from about 0.3 kilograms per cubic meter to about 0.9 kilograms per cubic meter.
